(19) United States
(12) Patent Application Publication
(10) Pub. No.: US 2006/0126541 A1
(43) Pub. Date: Jun. 15, 2006

(54) Method for detecting error of system information in mobile communication system

(75) Inventor: Hee-Jung Park, Incheon (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG-Nortel Co., Ltd.

(21) Appl. No.: 11/291,240

(22) Filed: Nov. 30, 2005

(30) Foreign Application Priority Data
Nov. 30, 2004 (KR) 10-2004-0099260

(51) Int. Cl. H04L 5/22

(52) U.S. Cl. 370/300; 370/537

(57) ABSTRACT

A method for detecting an error of system information in a mobile communication system is disclosed. A radio resource control (RRC) packet data unit (PDU) is created to transmit system information and the length of the RRC PDU is checked to determine if an error exists, with the RRC PDU sent to user equipment through a primary common control physical channel (PCCPCH) if no error exists.

### CROSS-REFERENCE TO RELATED APPLICATIONS

Pursuant to 35 U.S.C. § 119(a), this application claims the benefit of earlier filing date and right of priority to Korean Application No. 99260/2004, filed on Nov. 30, 2004, the contents of which are hereby incorporated by reference herein in their entirety

### BACKGROUND OF THE INVENTION

1. Field of the Invention

The present invention relates to a mobile communication system, and more particularly to, a method for detecting an error in system information that enables system information to stably updated in the mobile communication system.

2. Description of the Related Art

In general, a mobile communication system allows a user to communicate with other users through radio paging and a wireless connection any time and anywhere while moving in a service area. With the development of mobile communication-related techniques, mobile communication systems can perform data communication and multimedia communication as well as a communication using a voice grade signal.

There are various mobile communication systems, such as code division multiple access (CDMA), time division multiple access (TDMA), frequency division multiple access (FDMA) and global system for mobile communication (GSM). International Mobile Telecommunication 2000 (IMT-2000) is a standard for third-generation mobile communication systems that was defined by ITU (International Telecommunication Union) for supporting better quality multimedia services regardless of regions. Among many technical standards for the IMT-2000 are a universal mobile telecommunications system (UMTS) and a code division multiple access 2000 (CDMA 2000), which were completed by two major international standard organizations, respectively, 3rd Generation Partnership Projects (3GPP) and 3GPP2, a full-scale commercialization service currently being launched or prepared in Japan, Europe and Korea.

Specifically, the UMTS is a third-generation mobile communication system developed from the European Standard GSM for providing an improved mobile communication service using wideband code division multiple access (W-CDMA). A construction of a conventional UMTS will be described with reference to FIG. 1.

FIG. 1 illustrates the construction of a conventional UMTS. As illustrated in FIG. 1, the conventional UMTS includes user equipment (UE) 300, a UMTS terrestrial radio access network (UTRAN) 200 and a core network (CN) 100. The UTRAN 200 includes a plurality of radio network subsystems (RNS) 210, each of which includes one radio network controller (RNC) 200 and a plurality of base stations (Node-Bs) 230 managed by the RNC 220.

The Node-Bs 230, which are managed by the RNC 220, receive information sent by the physical layer of the user equipment 300 through an uplink and transmit data to the user equipment through a downlink. The Node-Bs 230 operate as access points of the UTRAN 200 for the user equipment 300. The RNC 220 handles the assignment and management of radio resources and operates as an access point with respect to the core network 100.

FIG. 2 is a flow chart of a conventional method for broadcasting system information of the UMTS. Because the UMTS is a next generation mobile communication system being newly developed at the present time, a RRC PDU creation function using a system information update procedure between the RNC and the Node B and scheduling information within the Node B must meet 3GPP specification requirements.

The RNC 220 sets up a cell for the Node B 230 (S210). In order to set up a cell between the RNC 220 and the Node B 230, the RNC 220 sends a cell setup request message to the Node B 230 and the Node B 230 sends a cell setup response message to the RNC 220 in response to the cell setup request message.

The RNC 220 configures system information of the UMTS to be sent to the Node B 230 through the setup cell (S220). The system information includes one MIB (master information block), two SB (scheduling blocks) and 27 SIB (system information blocks).

The RNC 220 segments the information blocks to a predetermined size. The segments are roughly divided into four types: first segment, subsequent segment, last segment and complete.

The RNC 220 sends the Node B 230 a system information update request message containing the plurality of segments and parameters for determining scheduling information to indicate the sending time of the segments. The Node B 230 sends a system information update response message to the RNC 220 in response to the system information update request message (S23).

The parameters for determining scheduling information include SIB_REP and SIB_POS. SIB_REP is a parameter indicating the intervals during which the system information blocks are transmitted and SIB_POS is a parameter indicating a location of each system information block segment within a transmission period.

The Node B 230 creates a RRC PDU by coupling the plurality of sent segments. Coupling header information such as SFN, combination type and length to the segments of the received system information update message and performing Abstract Syntax Notation (ASN.1) encoding create a RRC PDU of 246-bits.

The Node B 230 creates a RRC PDU by coupling at least one segment. The RRC PDU can be defined as one of 11 combination types as listed in Table 1.

The Node-B 230 sends the created RRC PDU to the user equipment 300 at 20 ms intervals through a primary common control physical channel (PCCPCH) according to the scheduling information (IB_SG_REP, IB_SG_POS, SEG_COUNT). The UTRAN 200 periodically establishes a PCCPCH transmitting system information. The UTRAN 200 transmits a system information block (SIB) containing system information using the PCCPCH in order to update the system information.

In the conventional method for broadcasting system information in a mobile communication system, since the Node B creates a RRC PDU in order to transmit system information and sends the RRC PDU to the user equipment through a PCCPCH, if the Node B cannot detect an error in the created RRC PDU, system information having an error may be transmitted to the user equipment. The user equipment cannot be provided with a mobile communication service due to the reception of system information having an error and the reliability of the mobile communication system is decreased.

TABLE 1
RRC PDU Combination Types

```
  1) No Segment
  2) First Segment
  3) Subsequent Segment
  4) Last Segment Short
  5) Last Segment Short + First Segment Short
  6) Last Segment Short + one or several Complete
  7) Last Segment Short + one or several Complete + First Segment Short
  8) One or several Complete
  9) One or several Complete + First Segment Short
10) One Complete of size 215 to 226
11) Last Segment of size 215 to 222
```

Therefore, there is a need for a method to determine if errors occur in system information or a RRC PDU created from the system information before the RRC PDU is sent to user equipment. The present invention addresses these and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention is directed to provide a method for detecting an error in system information that facilitates stably updating system information in the mobile communication system. By checking the length of system information and/or a radio resource control (RRC) packet data unit (PDU) created from the system information according to a combination type of segments, an error may be detected before the system information is sent to user equipment.

In one aspect of the present invention, a method for detecting an error in system information in a mobile communication system is provided. The method includes creating a radio resource control (RRC) packet data unit (PDU) having system information, determining if an error exists by checking the length of either the system information or the RRC PDU and sending the RRC PDU to user equipment in the mobile communication system through a physical channel if it is determined that no errors exist.

Preferably, the method further includes separating the system information into a plurality of segments based on a transmission block size of the physical channel, creating the RRC PDU based on the plurality of segments and determining if an error exists by checking the length of the RRC PDU according to a type of the plurality of segments. It is contemplated that the method is performed in a UTRAN and the separating is performed in a radio network controller (RNC), the creating is performed in a Node B and the Node B determines if an error exists. It is further contemplated that the physical channel is a primary common control physical channel (PCCPCH).

Preferably, determining if an error exists further includes checking the length of the plurality of segments according to the type of the plurality of segments. It is contemplated that checking the length of the plurality of segments is performed in a radio network controller (RNC) that is part of a UTRAN.

It is contemplated that the type of the plurality of segments is one of eleven types; 1) No Segment, 2) First Segment, 3) Subsequent Segment, 4) Last Segment Short, 5) Last Segment Short+First Segment Short, 6) Last Segment Short+Complete List (Complete SIB Short), 7) Last Segment Short+Complete List (Complete SIB Short)+First Segment Short, 8) Complete List (Complete SIB Short), 9) Complete List (Complete SIB Short)+First Segment Short, 10) Complete SIB Short, and 11) Last Segment. Preferably, the length of the RRC PDU is not checked if the plurality of segments is type 1-3, 10 or 11.

It is contemplated that the length of the RRC PDU is computed according to the following equation if the plurality of segments is type 4; Combination Header IE Length (SFN Prime+Combination Type)+Last Segment Short IE Length (SIB Type+Segment Index)+Segment Length+Variable Data. Preferably, determining if an error exists includes determining if “Variable Data” exceeds 214 bits.

It is contemplated that the length of the RRC PDU is computed according to the following equation if the plurality of segments is type 5; Combination Header IE Length (SFN Prime+Combination Type)+Last Segment Short IE Length (SIB Type+Segment Index+Segment Length+Variable Data L1)+First Segment Short IE Length (SIB Type+Segment Count+Segment Length+Variable Data F1). Preferably, determining if an error exists includes determining if “Variable Data L1+Variable Data F1” exceeds 197 bits.

It is contemplated that the length of the RRC PDU is computed according to the following equation if the plurality of segments is type 6; Combination Header IE Length (SFN Prime+Combination Type)+Last Segment Short IE Length (SIB Type+Segment Index+Segment Length+Variable Data L1)+Complete SIB Short Header IE Length (Num of Complete)+Complete SIB Short IE Length C1 (SIB Type+Segment Length+Variable Data C1)+ . . . +Complete SIB Short IE Length CN (SIB Type+Segment Length+Variable Data CN). Preferably, determining if an error exists includes determining if “Variable Data L1+Variable Data C1+ . . . +Variable Data CN” exceeds 210-13*N bits.

It is contemplated that the length of the RRC PDU is computed according to the following equation if the plurality of segments is type 7; Combination Header IE Length (SFN Prime+Combination Type)+Last Segment Short IE Length (SIB Type+Segment Index+Segment Length+Variable Data L1)+Complete SIB Short Header IE Length (Num of Complete)+Complete SIB Short IE Length C1 (SIB Type+Segment Length+Variable Data C1)+ . . . +Complete SIB Short IE Length CN (SIB Type+Segment Length (8 bits)+Variable Data CN)+First Segment Short IE Length (SIB Type+Segment Count+Segment Length+Variable Data F1). Preferably, determining if an error exists includes determining if “Variable Data L1+Variable Data C1+ . . . +Variable Data CN+Variable Data F1” exceeds 193-13*N bits.

It is contemplated that the length of the RRC PDU is computed according to the following equation if the plurality of segments is type 8; Combination Header IE Length (SFN Prime+Combination Type)+Complete SIB Short Header IE Length (Num of Complete)+Complete SIB Short IE Length C1(SIB Type+Segment Length+Variable Data C1)+ . . . +Complete SIB Short IE Length CN (SIB Type+Segment Length+Variable Data CN). Preferably, determining if an error exists includes determining if “Variable Data C1+ . . . +Variable Data CN” exceeds 227-13*N bits.

It is contemplated that the length of the RRC PDU is computed according to the following equation if the plurality of segments is type 9; Combination Header IE Length (SFN Prime+Combination Type)+Complete SIB Short Header IE Length (Num of Complete)+Complete SIB Short IE Length C1(SIB Type+Segment Length+Variable Data C1)+ . . . +Complete SIB Short IE Length CN (SIB Type+Segment Length+Variable Data CN)+First Segment Short IE Length (SIB Type+Segment Count+Segment Length+Variable Data F1). Preferably, determining if an error exists includes determining if “Variable Data C1+ . . . +Variable Data CN+Variable Data F1” exceeds 210-13*N bits.

It is contemplated that if either the system information or the RRC PDU includes only one segment and the segment has a fixed size, it is determined that no errors exist. It is further contemplated that if either the system information or the RRC PDU includes only one segment and the segment has a variable size, determining if an error exists includes checking if a size of the variable data is less than 214 bits.

Preferably, if either the system information or the RRC PDU includes more than one segment, determining if an error exists includes checking if a size of the RRC PDU satisfies the following mathematical formula;

246−15−17*X−13*Y−4* ┌Y/(Y+1)┐≧Total Summation of Variable Data, where x is the number of type 2 and type 4 segments, Y is the number of type 8 segments, and ┌Y┐ indicates an integer such that Y<┌Y┐<Y+1.

The foregoing and other objects, features, aspects and advantages of the present invention will become more apparent from the following detailed description of the present invention when taken in conjunction with the accompanying drawings.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a conventional UMTS.

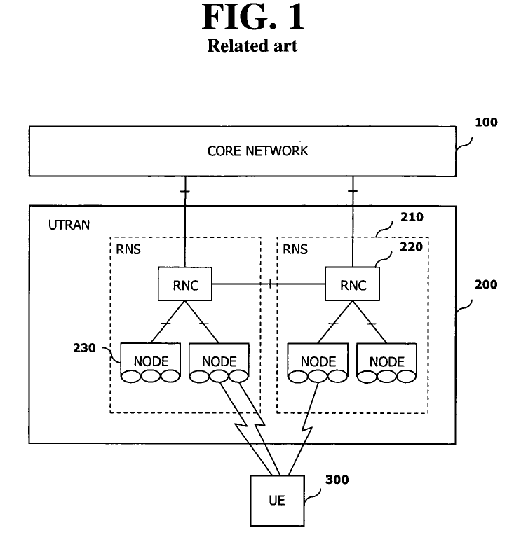

FIG. 2 illustrates a flow chart of a conventional method for broadcasting system information in a UMTS.

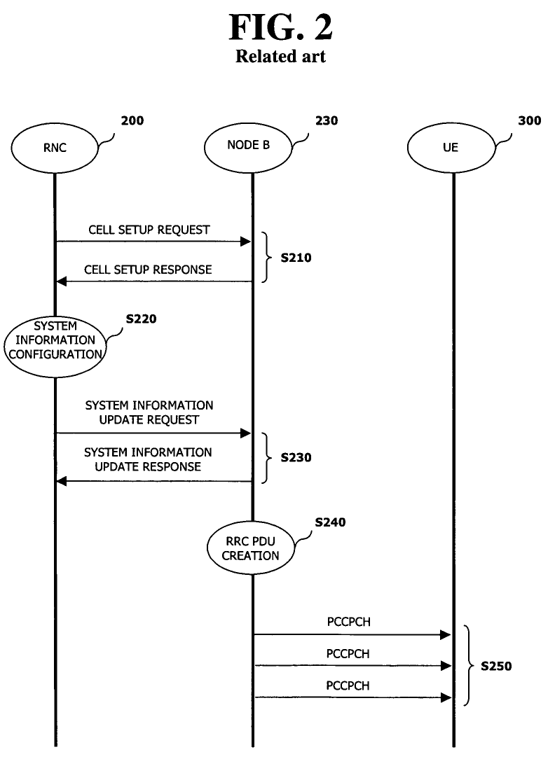

FIG. 3 illustrates a flow chart of a method for broadcasting system information in a UMTS in accordance with the present invention.

### DETAILED DESCRIPTION OF THE PREFERRED EMBODIMENTS

The present invention relates to a method for detecting an error in system information that enables system information to be stably updated in a mobile communication system. Although the present invention is illustrated with respect to a UTRAN and user equipment, it is contemplated that the present invention may be utilized anytime it is desired to detect an error in information that is transmitted between a system and a mobile communication device in a mobile communication system.

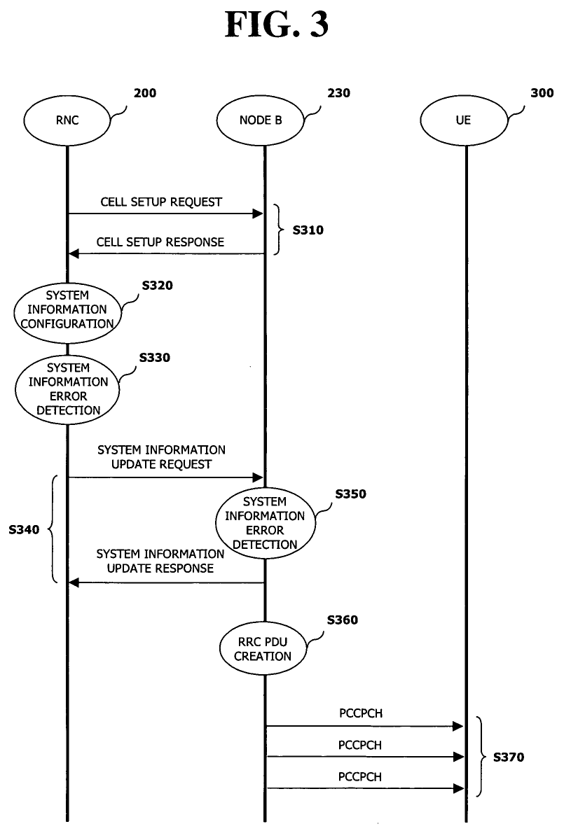

A method for detecting an error in system information in a mobile communication system that allows system information to be stably updated by checking the length of a radio resource control (RRC) packet data unit (PDU) according to a combination type of segments will be described with reference to the accompanying drawings. FIG. 3 illustrates a flow chart of a method for broadcasting system information in a UMTS in accordance with the present invention.

As illustrated in FIG. 3, the method for broadcasting system information in a UMTS in accordance with the present invention includes a RNC setting up a cell for a Node B (S310), the RNC configuring system information to be sent through the setup cell (S320), the RNC checking for an error in the configured system information (S330), the RNC sending the configured system information to the Node B in a plurality of segments if no error is detected (S340), the Node B checking for an error in the plurality of sent segments (S350), the Node B creating a RRC PDU based on the plurality of segments if no error is detected (S360) and the Node B sending the RRC PDU to user equipment (S370) through a primary common control physical channel (PCCPH).

The method for broadcasting system information in the UMTS in accordance with the present invention is the similar to the conventional method for broadcasting system information in the UMTS. Therefore, a detailed description will be omitted, with only the method for detecting an error in system information in the RNC and the Node B described in detail. Specifically, steps S330 and S350 illustrated in FIG. 3 will be described in detail.

First, the UTRAN 200 creates a RRC PDU in order to transmit system information and transmits the RRC PDU to the user equipment 300 at 20 ms intervals through the PCCPCH according to scheduling information. The RRC PDU is divided roughly into the combination types of segments illustrated in Table 2. Although the total length of all segment types is 246 bits, the composition of the types is different, as illustrated in Table 2.

TABLE 2
RRC PDU Combination Types

| TYPE | | COMPOSITION |
|---|---|---|
| 1) | No | Combination Header IE Length (SFN Prime (11 bits) + Combination Type (4 bits)) + Segment IE |
| | Segment | Length (231 bits) |
| 2) | First | Combination Header IE Length (SFN Prime (11 bits) + Combination Type (4 bits)) + First |
| | Segment | Segment IE Length (SIB Type (5 bits) + Segment Count (4 bits) + Fixed Data (222 bits)) |
| 3) | Subsequent | Combination Header IE Length (SFN Prime (11 bits) + Combination Type (4 bits)) + Subsequent |
| | Segment | Segment IE Length (SIB Type (5 bits) + Segment Index (4 bits) + Fixed Data (222 bits)) |
| 4) | Last | Combination Header IE Length (SFN Prime (11 bits) + Combination Type (4 bits)) + Last |
| | Segment | Segment Short IE Length (SIB Type (5 bits) + Segment Index (4 bits) + Segment Length (8 bits) + Variable |
| | Short | Data (1˜214 bits)) |
| 5) | Last | Combination Header IE Length (SFN Prime (11 bits) + Combination Type (4 bits)) + Last |
| | Segment | Segment Short IE Length (SIB Type (5 bits) + Segment Index (4 bits) + Segment Length (8 bits) + Variable |
| | Short + First | Data L1 (1˜214 bits)) + First Segment Short IE Length (SIB Type (5 bits) + Segment |
| | Segment | Count (4 bits) + Segment Length (8 bits) + Variable Data F1 (1˜214 bits)) |
| | Short | |
| 6) | Last | Combination Header IE Length (SFN Prime (11 bits) + Combination Type (4 bits)) + Last |
| | Segment | Segment Short IE Length (SIB Type (5 bits) + Segment Index (4 bits) + Segment Length (8 bits) + Variable |
| | Short + Complete | Data L1 (1˜214 bits)) + Complete SIB Short Header IE Length (Num of Complete |
| | List | (4 bits)) + Complete SIB Short IE Length C1 (SIB Type (5 bits) + Segment Length (8 bits) + Variable |
| | (Complete | Data C1 (1˜214 bits)) + . . . + Complete SIB Short IE Length CN (SIB Type (5 bits) + Segment |
| | SIB Short) | Length (8 bits) + Variable Data CN (1˜214 bits)) |
| 7) | Last | Combination Header IE Length (SFN Prime (11 bits) + Combination Type (4 bits)) + Last |
| | Segment | Segment Short IE Length (SIB Type (5 bits) + Segment Index (4 bits) + Segment Length (8 bits) + Variable |
| | Short + Complete | Data L1 (1˜214 bits)) + Complete SIB Short Header IE Length (Num of Complete |
| | List | (4 bits)) + Complete SIB Short IE Length C1 (SIB Type (5 bits) + Segment Length (8 bits) + Variable |
| | (Complete | Data C1 (1˜214 bits)) + . . . + Complete SIB Short IE Length CN (SIB Type (5 bits) + Segment |
| | SIB Short) + First | Length (8 bits) + Variable Data CN (1˜214 bits)) + First Segment Short IE Length ( |
| | Segment | SIB Type (5 bits) + Segment Count (4 bits) + Segment Length (8 bits) + Variable Data F1 |
| | Short | (1˜214 bits) |
| 8) | Complete | Combination Header IE Length (SFN Prime (11 bits) + Combination Type (4 bits)) + Complete |
| | List | SIB Short Header IE Length (Num of Complete (4 bits)) + Complete SIB Short IE Length C1 |
| | (Complete | (SIB Type (5 bits) + Segment Length (8 bits) + Variable Data C1 (1˜214 bits)) + . . . + Complete |
| | SIB Short) | SIB Short IE Length CN (SIB Type (5 bits) + Segment Length (8 bits) + Variable Data CN |
| | | (1˜214 bits)) |
| 9) | Complete | Combination Header IE Length (SFN Prime (11 bits) + Combination Type (4 bits)) + Complete |
| | List | SIB Short Header IE Length (Num of Complete (4 bits)) + Complete SIB Short IE Length C1 |
| | (Complete | (SIB Type (5 bits) + Segment Length (8 bits) + Variable Data C1 (1˜214 bits)) + . . . + Complete |
| | SIB Short) + First | SIB Short IE Length CN (SIB Type (5 bits) + Segment Length (8 bits) + Variable Data CN |
| | Segment | (1˜214 bits)) + First Segment Short IE Length (SIB Type (5 bits) + Segment Count (4 bits) + Segment |
| | Short | Length (8 bits) + Variable Data F1 (1˜214 bits) |
| 10) | Complete | = Combination Header IE Length (SFN Prime (11 bits) + Combination Type (4 bits)) + Complete |
| | SIB | SIB IE Length (SIB Type (5 bits) + Fixed Data (226 bits)) |
| 11) | Last | Combination Header IE Length (SFN Prime (11 bits) + Combination Type (4 bits)) + Last |
| | Segment | Segment IE Length (SIB Type (5 bits) + Segment Index (4 bits) + Fixed Data (222 bits)) |

Only those combination types having variable length components need to be checked for errors. Therefore, types 1-3, 10 and 11, which have no variable length components, are not checked for errors and types 4-9, which have variable length components, are checked for errors. Types 4-9 are checked for errors according to Table 3.

The method of checking the length of the divided RRC PDU according to types can be summarized into three general categories. If there is one segment and the segment has a fixed size, the Node B does not need to check the length of the RRC PDU. If there is one segment and the segment has a variable size, the Node-B checks if the size of the variable data exceeds 214 bits. If there are two or more segments, the Node B checks the length of the RRC PDU according the following mathematical formula:
246−15−17*X−13*Y−4*┌Y/(Y+1)┐≧Total Summation of Variable Data
where:

X is the number of First Segment Short or Last Segment Short

Y is the number of Complete Segment Short

┌Y┐ is an integer such that Y≦┌Y┐<Y+1

TABLE 3
Error Checking

| TYPE | ERROR CRITERIA |
|---|---|
| 1 | None |
| 2 | None |
| 3 | None |
| 4 | “Variable Data” exceeds 214 bits |
| 5 | “Variable Data L1 + Variable Data F1” exceeds 197 bits |
| 6 | “Variable Data L1 + Variable Data C1 + . . . + |
| | Variable Data CN” exceeds 210-13 * N bits |
| 7 | “Variable Data L1 + Variable Data C1 + . . . + |
| | Variable Data CN + Variable Data F1” exceeds 193-13 * N |
| | bits |
| 8 | “Variable Data C1 + . . . + Variable Data CN” |
| | exceeds 227-13 * N bits |
| 9 | “Variable Data C1 + . . . + Variable Data CN + |
| | Variable Data F1” does not exceed 210-13 * N bits |
| 10 | None |
| 11 | None |

As disclosed herein, the method for detecting an error of system information in the UMTS system in accordance with the present invention, such that the length of the RRC PDU is checked, can stably provide system information to user equipment since the RNC and the Node B can detect an error in the system information. Furthermore, the method in accordance with the present invention can stably update system information in the mobile communication system by checking the length of a RRC (radio resource control) PDU (packet data unit) depending upon a combination type of segments according to a predetermined method.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the many claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for detecting an error in system information in a mobile communication system, the method comprising:
creating a radio resource control (RRC) packet data unit (PDU) comprising system information;
determining if an error exists by checking the length of at least one of the system information and the RRC PDU; and
sending the RRC PDU to user equipment in the mobile communication system through a physical channel if it is determined that no errors exist.

2. The method of claim 1, further comprising:
separating the system information into a plurality of segments based on a transmission block size of the physical channel;
creating the RRC PDU based on the plurality of segments; and
determining if an error exists by checking the length of the RRC PDU according to a type of the plurality of segments.

3. The method of claim 2, wherein the method is performed in a UTRAN and the separating is performed in a radio network controller (RNC), the creating is performed in a Node B and the Node B determines if an error exists.

4. The method of claim 2, wherein determining if an error exists further comprises checking the length of the plurality of segments according to the type of the plurality of segments.

5. The method of claim 4, wherein the method is performed in a UTRAN and checking the length of the plurality of segments is performed in a radio network controller (RNC).

6. The method of claim 2, wherein the type of the plurality of segments is one of the following eleven types:
1) No Segment
2) First Segment
3) Subsequent Segment
4) Last Segment Short
5) Last Segment Short+First Segment Short
6) Last Segment Short+Complete List (Complete SIB Short)
7) Last Segment Short+Complete List (Complete SIB Short)+First Segment Short
8) Complete List (Complete SIB Short)
9) Complete List (Complete SIB Short)+First Segment Short
10) Complete SIB Short
11) Last Segment.

7. The method of claim 6, wherein the length of the RRC PDU is not checked if the plurality of segments is one of types 1-3, 10 and 11

8. The method of claim 6, wherein the length of the RRC PDU is computed according to the following equation if the plurality of segments is type 4:
Combination Header IE Length (SFN Prime+Combination Type)+Last Segment Short IE Length (SIB Type+Segment Index)+Segment Length+Variable Data.

9. The method of claim 8, wherein determining if an error exists comprises determining if “Variable Data” exceeds 214 bits.

10. The method of claim 6, wherein the length of the RRC PDU is computed according to the following equation if the plurality of segments is type 5:
Combination Header IE Length (SFN Prime+Combination Type)+Last Segment Short IE Length (SIB Type+Segment Index+Segment Length+Variable Data L1)+First Segment Short IE Length (SIB Type+Segment Count+Segment Length+Variable Data F1).

11. The method of claim 10, wherein determining if an error exists comprises determining if “Variable Data L1+Variable Data F1” exceeds 197 bits.

12. The method of claim 6, wherein the length of the RRC PDU is computed according to the following equation if the plurality of segments is type 6:
Combination Header IE Length (SFN Prime+Combination Type)+Last Segment Short IE Length (SIB Type+Segment Index+Segment Length+Variable Data L1)+Complete SIB Short Header IE Length (Num of Complete)+Complete SIB Short IE Length C1(SIB Type+Segment Length+Variable Data C1)+ . . . +Complete SIB Short IE Length CN (SIB Type+Segment Length+Variable Data CN).

13. The method of claim 12, wherein determining if an error exists comprises determining if “Variable Data L1+Variable Data C1+ . . . +Variable Data CN” exceeds 210-13*N bits.

14. The method of claim 6, wherein the length of the RRC PDU is computed according to the following equation if the plurality of segments is type 7:
Combination Header IE Length (SFN Prime+Combination Type)+Last Segment Short IE Length (SIB Type+Segment Index+Segment Length+Variable Data Li)+Complete SIB Short Header IE Length (Num of Complete)+Complete SIB Short IE Length C1(SIB Type+Segment Length+Variable Data C1)+ . . . +Complete SIB Short IE Length CN (SIB Type+Segment Length (8 bits)+Variable Data CN)+First Segment Short IE Length (SIB Type+Segment Count+Segment Length+Variable Data F1).

15. The method of claim 14, wherein determining if an error exists comprises determining if “Variable Data L1+Variable Data C1+ . . . +Variable Data CN+Variable Data Fl” exceeds 193-13*N bits.

16. The method of claim 6, wherein the length of the RRC PDU is computed according to the following equation if the plurality of segments is type 8:
Combination Header IE Length (SFN Prime+Combination Type)+Complete SIB Short Header IE Length (Num of Complete)+Complete SIB Short IE Length C1 (SIB Type+Segment Length+Variable Data C1)+ . . . +Complete SIB Short IE Length CN (SIB Type+Segment Length+Variable Data CN).

17. The method of claim 16, wherein determining if an error exists comprises determining if “Variable Data C1+ . . . +Variable Data CN” exceeds 227-13*N bits.

18. The method of claim 2, wherein the length of the RRC PDU is computed according to the following equation if the plurality of segments is type 9:
Combination Header IE Length (SFN Prime+Combination Type)+Complete SIB Short Header IE Length (Num of Complete)+Complete SIB Short IE Length C1(SIB Type+Segment Length+Variable Data C1)+ . . . +Complete SIB Short IE Length CN (SIB Type+Segment Length+Variable Data CN)+First Segment Short IE Length (SIB Type+Segment Count+Segment Length+Variable Data F1).

19. The method of claim 18, wherein determining if an error exists comprises determining if “Variable Data C1+ . . . +Variable Data CN+Variable Data Fl” exceeds 210-13*N bits.

20. The method of claim 2, wherein if the at least one of the system information and the RRC PDU comprises only one segment and the segment has a fixed size, it is determined that no errors are present.

21. The method of claim 1, wherein at least one of the system information and the RRC PDU comprises only one segment has a variable size, determining if an error exists comprises checking if a size of the variable data is less than 214 bits.

22. The method of claim 1, wherein if the at least one of the system information and the RRC PDU comprises more than one segment, determining if an error exists comprises checking if a size of the RRC PDU satisfies the following mathematical formula:
246−15−17*X−13 *Y−4*┌Y/(Y+1)┐≦Total Summation of Variable Data,
wherein x is the number of type 2 and type 4 segments, Y is the number of type 8 segmens, and ┌Y┐ indicates an integer such that Y≦┌Y┐<Y+1.

23. The method of claim 1, wherein the physical channel is a primary common control physical channel (PCCPCH).
